(19) United States
(12) Patent Application Publication
(10) Pub. No.: US 2015/0161735 A1
(43) Pub. Date: Jun. 11, 2015

(54) INVESTMENT INSTRUMENT

(71) Applicant: Aniket Parikh, Scarsdale, NY (US)

(72) Inventor: Aniket Parikh, Scarsdale, NY (US)

(21) Appl. No.: 14/622,898

(22) Filed: Feb. 15, 2015

Related U.S. Application Data
(63) Continuation of application No. 14/080,012, filed on Nov. 14, 2013.

(51) Int. Cl. G06Q 40/06

(52) U.S. Cl. CPC G06Q 40/06

(57) ABSTRACT

A novel investment instrument, and associated method of using said investment instrument, for investing in assets, holding assets, and exiting the investment through an investment company. Specifically, the investment instrument and method of an embodiment of the present invention comprises the steps of an investor investing funds, or assets in kind, into an investment company, the investor choosing at least an asset for the investment, and offering to the investor the option to take possession of the chosen asset, while title to the asset remains with the investment company, or asset owner, for the duration of the investment period.

### CROSS-REFERENCE TO RELATED APPLICATIONS

This application is a CONTINUATION application of PENDING U.S. Non-Provisional patent application Ser. No. 14/080,012, filed on Nov. 14, 2013, which claims the benefit of, and is a non-provisional application of, U.S. Provisional Patent Application No. 61/726,716, filed on Nov. 15, 2012, all of which are incorporated herein by reference.

### STATEMENT REGARDING FEDERALLY SPONSORED RESEARCH OR DEVELOPMENT

Not applicable.

### FIELD OF THE INVENTION

This invention relates to the field of investment instruments.

### BACKGROUND

In finance, investment is the commitment of funds through collateralized lending, or making a deposit into a secured institution. To avoid speculation, an investment has been either directly backed by the pledge of sufficient collateral or insured by sufficient assets pledged by a third party. The types of investments can include equity, debt securities, real estate, currency, derivatives and commodities such as precious metals and gemstones.

Historically, precious metals were important as currency but are now regarded mainly as investment and industrial commodities. Further, the precious metals may be used as a hedge against inflation, deflation or currency devaluation. The best-known precious metals are the coinage metals: gold, silver and platinum. Of all the precious metals, gold is the most popular as an investment.

Conventionally, the individual investor and institutional investor can invest in precious metals through various investment vehicles such as bars, coins, Exchange traded products, certificates, accounts, derivatives, contracts for difference (CFDs), and spread betting disadvantages. Attempts have been made in the prior art to diversify the investment vehicle option in physical precious metals.

In some cases, the prior art discloses a system for purchasing precious metals at fixed-monitory amount by a client, particularly a website for subscription registration, balance inquiries, same-day spot purchases, returns, sales, equal-value exchanges and investment, etc. The purchased precious metals by the clients has been placed in protective custody in a client account established with a purchasing organization, however the purchasing organization or system is not allowing the client to use, hold, or otherwise take possession of the precious metals during the investment period.

In other cases, the prior art discloses a computer-implemented precious metals investment product and process for pricing a precious metals composite product, wherein the measured unit of a plurality of precious metal components is quoted and traded as a unit, thus allowing for uniformity in the ongoing offers to buy and sell a fixed quantity, or multiples of this fixed quantity, and pricing consistency for the metals. But the patent application fails to provide an option to client to take delivery of the precious metals without ownership of such metals.

Still other instances of the prior art disclose an investment method for providing a positive return on the precious metal holding, wherein a special purpose vehicle being an enterprise is disposed to receive a purchase request from purchaser for purchasing the weight of the precious metal for the purchaser in response to the purchase request, to hold the purchased precious metal or derivative in trust, and to use the held precious metal as value/collateral for funding investments to derive a return on the investment. However, the purchaser is not allowed to hold the precious metal for his usage along with the investment benefit associated with the precious metals.

Information relevant to attempts to address the problems found in the current state of the art, as described above, can be found in U.S. Patent Application Nos. US 20020087428 A1, US 20110258102 A1, and US 20070088647 A1. However, each one of these references suffers from one or more of the following disadvantages: the investment method does not allow for the case where the investor wants to take possession of or use the asset in which he has invested; the investment instrument fails to provide an option for the client to take delivery of the assets without ownership of said assets; and the purchaser is not allowed to hold the asset for his usage along with the investment benefit associated with the asset.

It would, therefore, be desirable to have an investment instrument and associated method of using said investment instrument that at least provides for the investor taking possession of the investment asset, the investor taking delivery of the asset without taking ownership, and the investor holding the asset for his use in addition to receiving the investment benefit of the asset.

While certain aspects of conventional technologies and methods in the relevant art have been discussed to facilitate disclosure of the invention, Applicant in no way disclaims these technical aspects or methods, and it is contemplated that the claimed invention may encompass one or more of the conventional technical aspects or methods discussed herein.

In this specification, where a document, act, or item of knowledge is referred to or discussed, this reference or discussion is not an admission that the document, act, or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY

In this specification and in the appended claims and drawings, words and phrases have the meanings commonly attributed to them in the relevant art except as otherwise specified herein.

In this specification and in the appended claims and drawings, “asset”, including grammatical equivalents, singular and plural, is the object of an investment, which may be a tangible property, such as, but not limited to, jewelry, art, precious metals, or precious stones, or a intangible property, such as, but not limited to, a futures contract. A single “asset” may also be comprised of multiple assets, but grouped as a single investment such as in jewelry or in a lot of goods. An “asset” may have associated with it any combination of a cost of acquisition, a markup cost, and/or a markdown cost.

In this specification and in the appended claims and drawings, “liquidation value” is either the instant, spot cash, or distress sale price that makes the asset saleable in order to convert the asset to liquid cash.

In this specification and in the appended claims and drawings, “buy back value” is the pre-determined contract value. This buy back value may be a fixed monetary amount or it may be a value calculated based upon predetermined criteria such as, but not limited to, the quality or condition of the asset after use, and/or other pricing functions based on prices at the future date.

In this specification and in the appended claims and drawings, “melt value” is the monetary value that may be derived from the component parts of an asset. For example, the melt price of a piece of jewelry comprised of a precious stone and a base metal is the monetary value of precious stone plus the value of the base metal after melting down. Melting the base metal generally creates a loss in the labor value that was used to make the jewelry while the precious stones, which are not melted down, may not lose their labor value. By way of further example, the term “melt value” is also used in this specification in reference to, for example, art, which is typically not actually “melted” but, nonetheless, may be appraised for its component value to the extent that it can be divided into component parts (as in a painting and its frame).

In this specification and in the appended claims and drawings, “credit instrument” is any instrument that allows for the store of monetary wealth that can be used to buy goods and services, or traded for cash equivalents including stocks and shares in lieu. Credit instruments can be, but are not limited to, credit cards, online accounts having a cash balance, debit cards, or gift cards. Credit instruments are conveyed in conjunction with, or dependent on, a credit instrument contract, or terms of service, that defines aspects of the agreement such as, but not limited to repayment terms and variable credit limits.

In this specification and in the appended claims and drawings, “memo” is the taking of goods on consignment. It is also referred to as a “memorandum”. For example, party X agrees to give merchandise to party Y to try to sell, or to a third party, or to buy for himself at a particular price and on certain terms of payment and for a period of time. The possession goes to party Y, but the ownership remains with X until a sale is confirmed and the parties agree upon the sale.

In this specification and in the appended claims and drawings, “funding of an investment” is contemplated to include non-cash funds. For example, an asset, a financial instrument, or another item of value, or a combination thereof, may be utilized to fund an investment.

The present invention may address one or more of the problems and deficiencies of the prior art discussed above. However, it is contemplated that the invention may prove useful in addressing other problems and deficiencies in a number of technical areas. Therefore the claimed invention should not necessarily be construed as limited to addressing any of the particular problems or deficiencies discussed herein.

In view of the foregoing, an embodiment herein provides a novel investment instrument, and associated method of using said investment instrument, for investing in assets, holding assets, and exiting the investment through an investment company. Specifically, the investment instrument and method of an embodiment of the present invention comprises the steps of an investor investing funds, or assets in kind, into an investment company, the investor choosing at least an asset for the investment, and offering to the investor the option to take possession of the chosen asset, while title to the asset remains with the investment company, or asset owner, for the duration of the investment period.

The investment method may further comprise the step of investor receiving at least a credit instrument.

The investment company can comprise various divisions, including, but not limited to, a banking division, an insurance division, an asset division, a factory division, and a retail division, wherein one or more investors can invest on at least an asset through the investment company.

The investors can include at least one, some, or all of, a consumer, small retail investor, retailer, franchisee, institutional investor, manufacturer, designer, traders, or a mining company. Embodiments of the present invention disclosed herein, as well as other embodiments contemplated to be within the scope of the claims, may be carried out by any one, some, or all of the investor types described above. Naming of one investor type in any particular embodiment is by way of illustration only and not intended as any limitation on the invention or how it may be practiced.

Retail sales profits need not be booked at the moment of sale but can slowly be booked over an extended period of time, or at the end of a specified period of time, especially for investible products or products that have some residual value over time. Retail profit can be used to give credit back to the consumer and, in doing so, can be used as an investment vehicle and over time, whereby, the consumer gets full value for the product as well as enjoyment for its use.

### BRIEF DESCRIPTION OF THE DRAWINGS

These and other features, aspects, and advantages of the present invention will become better understood with regard to the following description, appended claims, and accompanying drawings where:

FIG. 1 illustrates a block diagram of investment method for investors to invest on assets through an investment company according to an embodiment herein;

FIGS. 2.1 to 2.5 illustrates flow chart(s) of a consumer's interaction with the investment company according to an embodiment herein;

FIGS. 3.1 to 3.2 illustrates flow chart(s) of a small retail investor's interaction with the investment company according to an embodiment herein;

FIGS. 4.1 to 4.4 illustrates flow chart(s) of a retailer's interaction with the investment company according to an embodiment herein;

FIG. 5 illustrates a flow chart of a franchisee's interaction with the investment company according to an embodiment herein;

FIG. 6 illustrates a flow chart of a manufacturer's interaction with the investment company according to an embodiment herein;

FIG. 7 illustrates a flow chart of a mining company's interaction with the investment company according to an embodiment herein;

FIGS. 8.1 to 8.2 illustrates flow chart(s) of an institutional investor's interaction with the investment company according to an embodiment herein;

FIG. 9 illustrates a flow chart of a designer's interaction with the investment company according to an embodiment herein;

FIG. 10 illustrates a flow chart of an asset trader's interaction with the investment company according to an embodiment herein.

### DESCRIPTION

In the Summary of the Invention above, in the Description and appended Claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

While the specification will conclude with claims defining the features of embodiments of the invention that are regarded as novel, it is believed that the invention will be better understood from a consideration of the following description in conjunction with the figures, in which like reference numerals are carried forward.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

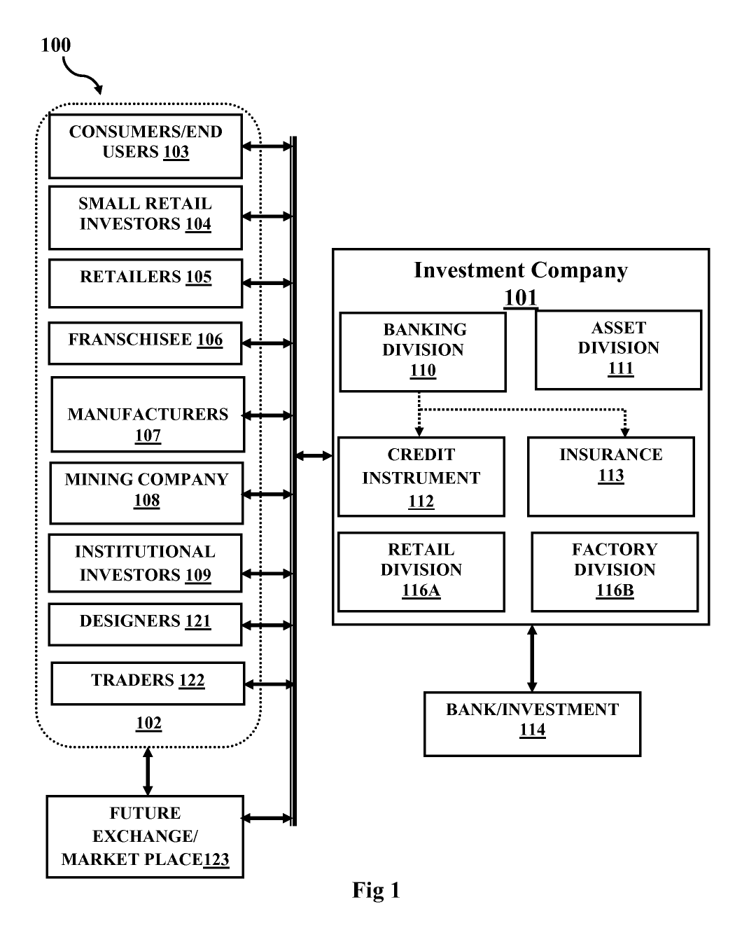

FIG. 1 illustrates a block diagram 100 of investment method for investors 102 to invest in assets through an investment company 101 according to an embodiment. The investors 102 can include, but are not limited to, consumers 103, small retail investors 104, retailers 105, franchisee 106, manufacturers 107, mining companies 108, institutional investors 109, designers 121 and traders 122. Further, the investors 102 can invest or trade through a futures exchange or marketplace 123. The investment company 101 can include, but is not limited to, a banking division 110, an asset division 111, a retail division 116a, and a factory division 166b. The banking division, a third party, or both can issue, a credit instrument 112 to the investors 102. The credit instrument can be valid for any amount of time, but in some implementations the term of the credit instrument will coincide with the timing of other significant events, as explained below. Further, the insurance division 113 can provide, or have a third party provide, insurance 113 and insurance products for the investment fund and/or asset for any term. The retail division 116A interacts with third party providers of goods and services who, in turn, can also indirectly issue credit of a different nature. The retail division can sell their own, or third party, products, goods and services and convert profit from those sales into income earned.

In an embodiment, the asset division 111 can include, but is not limited to, a trading department or a consumer services center, which can enable non-industry investors to buy and sell assets through the investment company's 101 own traders. Further, the investors can also elect representatives to act as traders on their behalf to deal in the asset invested. The asset division may further elect to hold some or all of the assets themselves, or utilize a third party to hold some or all of the assets on their behalf.

According to an embodiment, the investors 102 can invest funds into the investment company 101 for investment in an asset, wherein title to the asset is retained by the investment company 101 or third party asset owner and offer for possession of the asset for a pre-determined period of time. In some embodiments, the investor 102 is presented an option to purchase the asset. In some embodiments, this option to purchase vests at the expiration of the credit instrument. Further, the funds received at banking division 110 can be invested into the bank or investments 114 such as a cash fund, a physical asset, an insurance policy, or any other investment type.

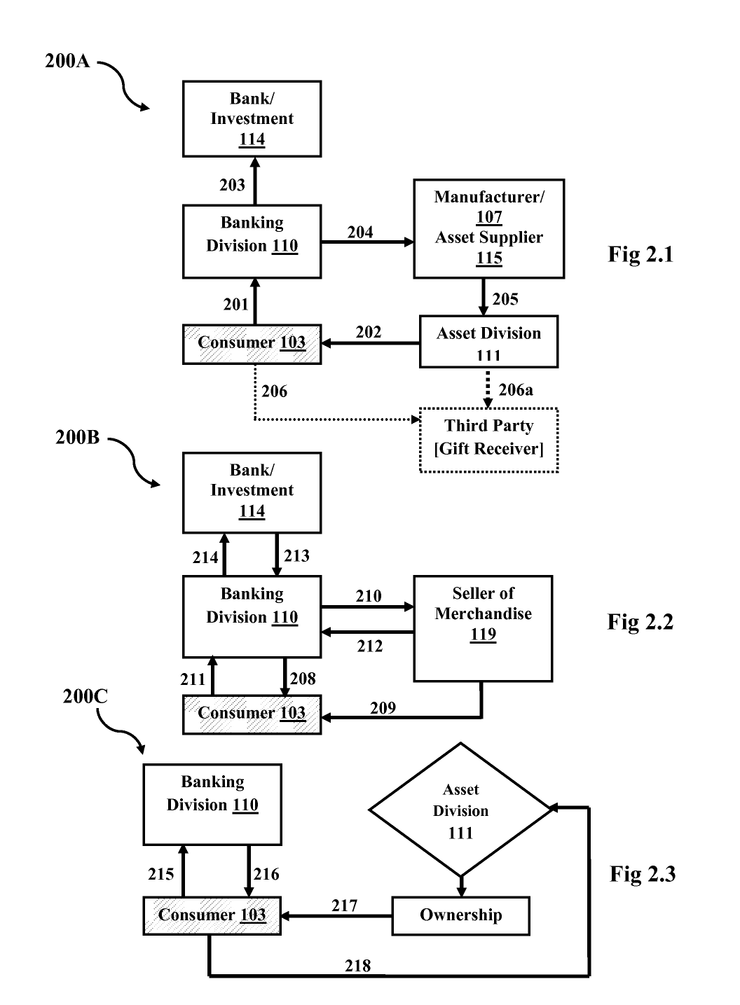

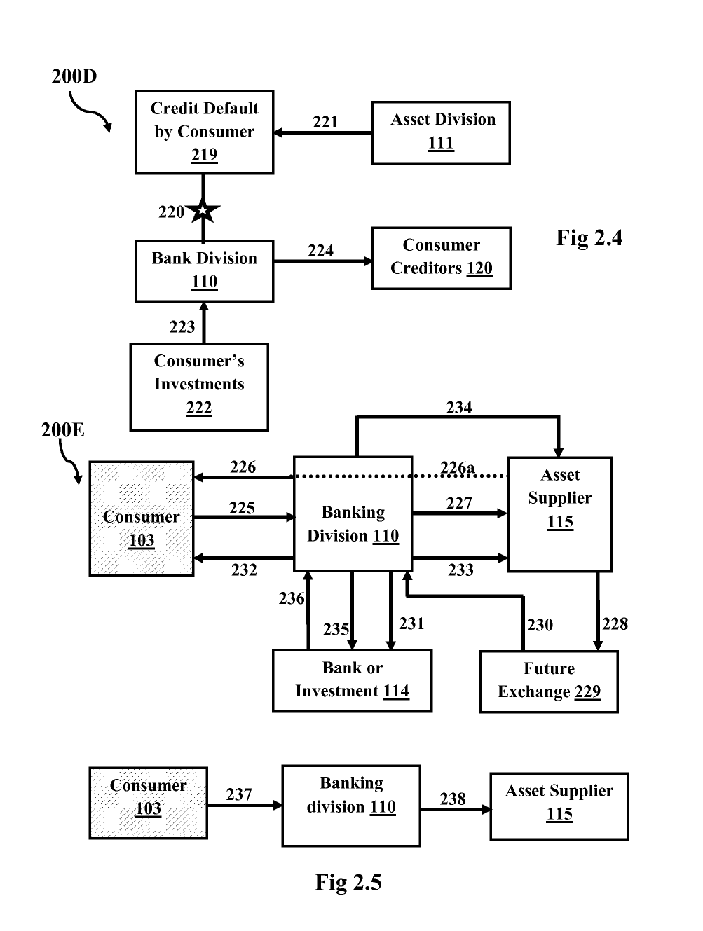

FIG. 2.1 illustrates a flow chart 200A of a consumer's 103 investment with the investment company 101 according to an embodiment. Accordingly, the consumer 103 invests funds 201 into the banking division 110 for investment in an asset, and receives 202 possession of the asset from the asset division 111, or from franchisee 106. In some embodiments, the choice of asset for investment may be made directly by the investor, indirectly through the investor's representative or the investment company's traders, or automatically per a computer-based choice algorithm. Title to the asset remains with the investment company 101, or third party owner, until the end of the investment period, and a right of possession only transfers to the investor, or to a third party as in the case of the asset being gifted by the investor. The fund received at bank division 110 is utilized for investing 203 in bank or for purchasing 205 other assets from asset supplier 115 to own the additional assets, preferably at the asset division 111, but, at times, at a third party. In another embodiment, the consumer 103 can further accept an option to give a gift 206, in the form of the asset, a gift card, or other gifting instrument, to a gift receiver, thereby transferring his right of possession to the gift receiver thereby enabling the gift receiver to receive the gift 206a either from the investor directly, from the asset division 111, or from a franchisee 106 of the asset division 111. In the event that the investor accepts the option to give a gift 206 to a gift receiver, the titleholder agrees to transfer of possession from the investor to the gift receiver while retaining ownership of the gift. At the end of the investment period, the investor must purchase the asset, or accept as investment deemed repaid as per contract terms, and transfer title to the gift receiver. The gift receiver, in turn, may exchange or return the gift as per terms conditions and values specified with the gift.

FIG. 2.2 illustrates a flow chart 200B of a consumer 103 receiving a credit instrument 112 from the investment company 101 according to an embodiment. The banking division 110 issues 208 at least a credit instrument 112 to the consumer 103, wherein the credit limit and duration for the credit instrument 112 can vary or depend upon factor such as, but not limited to, the consumer's invested fund. In an embodiment, the banking division 110 can make 210 the payment to the sellers 119 for the goods or services bought on credit by consumer 103. Accordingly, the consumer 103 needs to make 211 payback of credit and any interest on due date as per terms and conditions of the credit instrument 112 to the banking division 110. Further, the banking division 110 may receive 212 any commission, cash back, or other income from sellers 119 based on the transaction conducted through the credit instrument issued to the consumer 103. In a further embodiment, the banking division 110 may receive 213 a loan from the bank 114 if needed to cover the credit instrument 112 and may return the loan along with interest to bank 114, and also can invest 214 any income received from the consumer 103 and the sellers 119 to the bank 114, or, optionally, keep these receipts as profit.

In an embodiment of the present invention, the invention may comprise, but is not limited to, an investor being presented with an option to purchase a financial instrument based on the asset-backed investments made by him or others, said financial instrument that can either be converted to the form of a currency, either at, on, or before the time of maturity of the financial instrument, or with options given and/or profit or loss booked at that time. These financial instruments can also be traded for goods and services or derivatives options. The currency, backed by the asset, the physical asset, the investment, or both, and with interest rate and other derivative functions, would play as a hedge as well as an investment. One of the measures of strength of this currency would be based on the ability to buy goods and services over time, and adjusted for inflation and could be gauged against a basket of goods and services, among other things. This currency would, therefore, act as a currency peg in the future based on the assets backing it, as well as serve as a tradable currency or instrument, tradable on the futures exchange, the marketplace, or on other platforms that it may be tradable on. For example, an investor can buy an option or take ownership against an asset already invested in (by himself, or any other investor) in his local currency if he felt the local currency was going to devalue. Then sell the asset to another investor, domestic or foreign, when the asset appreciates in the local currency in case of devaluation. In reverse, he could short sell an option of the asset at a higher currency level or give up ownership of his asset (an option may be given so he may not need to give up possession) and then buy it back when the currency re-values at a lower cost in local currency terms. Similarly, the trading of non-physically backed asset trades would create a futures market and allow, say, diamond manufacturers and other players to buy or sell their products before hand and thus reduce their holding time of the asset as well as allow them to calculate the cost of the rough product they need to buy at. On the other hand, an entity such as a jewelry manufacturer can buy the diamonds he needs, deliverable perhaps at a future date, and know the cost and availability of his product. Or make a futures contract to buy the assets/investments or a basket of these from one or multiple investors. An investor may also invest in futures or other such instruments/derivatives of the assets in a basket of currencies to hedge against that currency.

FIG. 2.3 illustrates a flow chart 200C of a consumer 103 purchasing or returning the chosen asset from the investment company 101 according to an embodiment. In order to purchase, and take legal ownership of, the chosen asset, the consumer 103 may have to settle accounts 215 with the bank division 110 for any or all open credit, along with interest and charges due, if any. Further, the bank division 110 may pay 216 out in cash, or in kind through the asset division, to the consumer 103 for any balance of the invested funds, wherein the balance would be the invested fund value in bank division 110 after deducting the melt value or actual value of the purchased asset. The asset division 111 makes the sale deed of the asset and returns the asset, less any applicable taxes, fees, etc., with title 217 to the consumer 103. In some implementations, the consumer 103 can purchase the asset pursuant to an option to purchase under certain terms set forth at the beginning of the investment. Such terms could include a fixed price or a variable price (e.g., an option to purchase at prevailing market rates at the time the option vests).

In an embodiment, the consumer 103 can return the chosen asset to the investment company 101 after using or holding the chosen asset. Accordingly, the consumer 103 may return 218 the chosen asset to the asset division 111, or to a representative of the asset division such as a franchisee. Thereafter, the consumer 103 may have to clear 215 the payment to the bank division 110 for any, or all, open credit, along with interest, if any. Further, the bank division 110 may pay out 216 in cash or in kind to the consumer 103 for cash out value, wherein the cash out value would be invested fund along with melt value of the asset, or as per any buy back value as determined by contract made between the parties. In some embodiments, the in kind payout to the consumer may be in the form of assets, third party gift cards, or some other type of financial instrument such as stocks, or a combination of these.

FIG. 2.4 illustrates a flow chart 200D for the case where a consumer 103 defaults according to an embodiment. Accordingly, in case the consumer 103 defaults 219 on credit or loan, then the banking division 110 can terminate 220 the credit instrument 112, and/or the contracts created by the investor, and the chosen asset can be deemed 221 to be sale of asset, or deemed otherwise paid, in accordance with the terms of the investment agreement. Further, all the investment fund owned 222 by the consumer 103 may be deemed paid to the consumer 103 and the company 101 can own all remainder of the asset and investment 223. Additionally, the banking division 110 may make 224 payment of any taxes or debt to the consumer's creditors 120 if debt is not recoverable.

FIG. 2.5 illustrates a flow chart 200E, according to an embodiment, of a consumer 103 interaction with the investment company 101, wherein the consumer 103 is not willing to buy an asset. Accordingly, the consumer 103 invests 225 cash or funds into the banking division 110 for receiving 226 the chosen asset for the term of contract, say ‘x’ years, to hold or use, wherein the asset is supplied 226a from the asset supplier 115. Further, the banking division 110 may provide 227 loans equivalent to the asset amount to the asset supplier 115 or cash equivalent to the asset amount may be reinvested into new assets and hold the new assets by asset division 111 on behalf of the asset supplier 115. Moreover, the asset supplier 115 can short sell 228 the asset on a futures exchange 229, or alternatively to the investment company or other investors, in case the supplier 115 does not want to wait until the end of the contract period and exit the trade. The cash earned from the short sale can be kept 230 in the bank division 110 and/or re-invested 231. Further, the banking division 110 can invest 235 the cash and/or excess cash into the bank/investment 114, and receive 236 profits or loss on investment from bank 114. At maturity of the contract term, the consumer 103 returns the asset to the asset division 111 and gets 232 cash back for the amount based on the contract value. The bank division 110 provides 233 profits or loss on investment and/or provides 234 profits or loss on short sell investment to the asset supplier 115. Further, at the end of the contract, the consumer may make a payment 237, such as cash, for interest and depreciation on the asset to the banking division 110, which, in turn, is returned 238 to the asset supplier 115 as a profit to him.

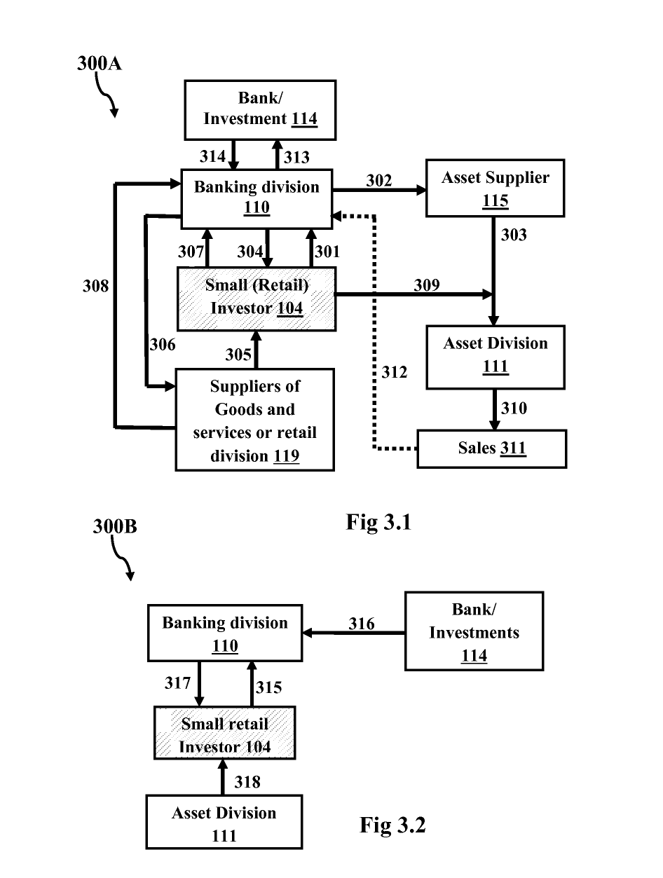

FIG. 3.1 illustrates a flow chart 300A of a small retail investor's 104 interaction with the investment company 101, according to an embodiment. Accordingly, the small retail investor 104 can invest 301 funds to the banking division 110, wherein the invested fund is sent 302 to at least an asset supplier 115 for receiving 303 assets in the asset division 111. The small retail investor does not take possession of the product to use for himself and, as such, may not be subject to the asset markup as in the case when an investor takes possession of the asset. In this case, the small retail investor may enter into other optional contracts such as converting the asset into cash, sale of the asset, or taking delivery of the asset as some of the ways to exit the investment.

In an embodiment, the banking division 110 issues 304 a credit instrument 112 to the small retail investor 104 thereby creating free cash flow to the small retail investor 104 enabling it to buy 305 products and/or services on credit from suppliers 119. In an embodiment, the banking division 110 can make 306 the payment to the supplier 119 for the goods or services bought on credit by small retail investor 104. Accordingly, the small retail investor 104 may make 307 payback of credit and any interest on due date as per terms and conditions of the credit instrument 112. Further, the banking division 110 may receive 308 any commission or cash back from sellers based on the transaction on credit by small retail investor 104.

In an embodiment, the small retail investor 104 can choose 309 at least an asset for the invested fund, and the bank division 110 makes cash payment 302 to the asset supplier 115. The chosen asset is received and kept 303 at asset division 111 for selling 310 the asset for sale 311. After the sale 311 of asset, the amount of cash derived on sale is sent 312 to the banking division 110 for investing 313 in the bank profits or loss from the investment 114 for the invested amount.

FIG. 3.2 illustrates a flow chart 300B for end of investment of the small retail investor 104 with the investment company 101 according to an embodiment. Accordingly, at the end of investment, the small retail investor 104 needs to make 315 payments for credit and/or any taxes if applicable. Further, all the investments are liquidated and return on investment is sent 316 to the banking division 110, thereafter profit or loss on investment is paid 317 to the small retail investor 104. In a further embodiment, if the asset is not sold, the asset division 111 can send 318 the physical assets to the small retail investor 104, or optionally the assets can be sold on a futures exchange for liquidating the asset and to get cash value for it.

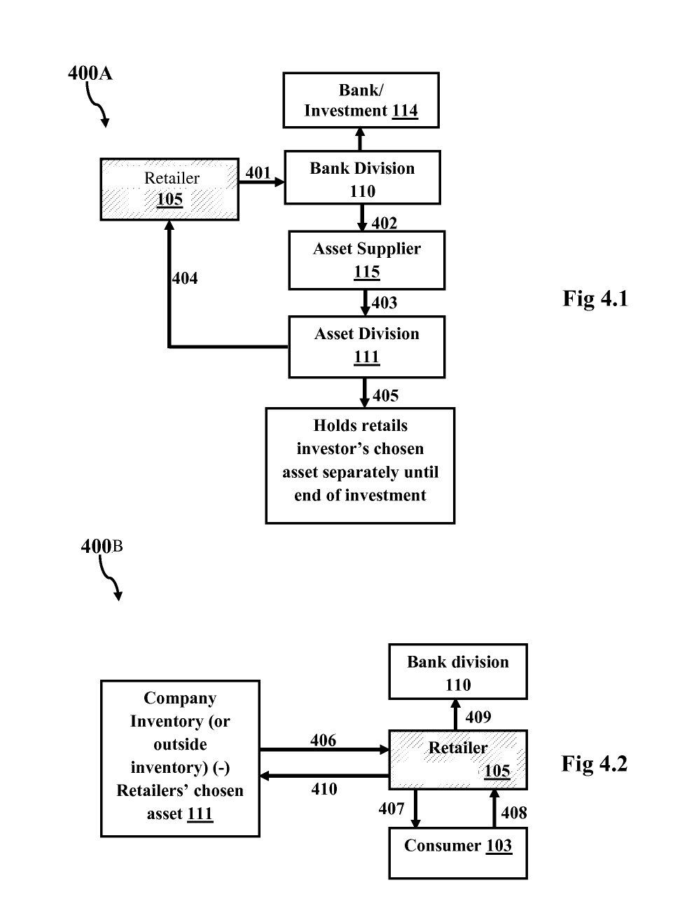

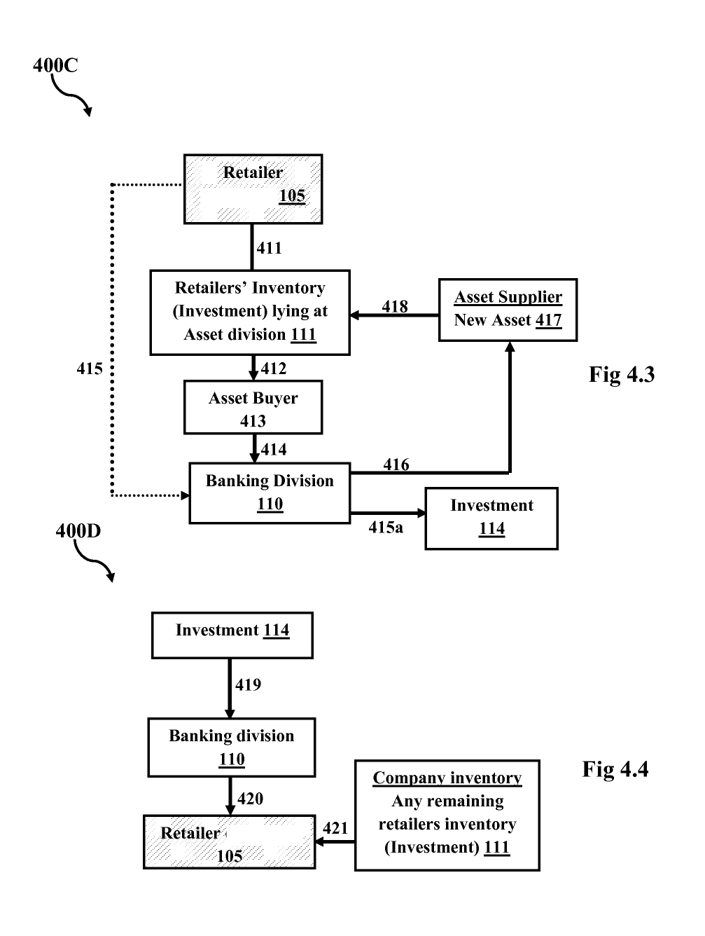

FIG. 4.1 illustrates a flow chart 400A of a retailer, acting as an investor, and their interaction with the investment company 101, according to an embodiment. Accordingly, the retailer 105 can invest 401 funds to the banking division 110 for choosing at least an asset, wherein the invested fund is sent 402 to the asset supplier 115 for receiving 403 chosen asset in the asset division 111. In the case that the invested fund is a non-cash investment, the asset may remain with the investment company who will then pay the asset supplier. Further, the retailer 105 can receive 404 the assets on memo for selling, but at the same time, the company asset division 111 holds 405 retailer's chosen asset separately and it does not go to the retailer 105 until the end of investment.

FIG. 4.2 illustrates a flow chart 400B for sale or return of merchandise of the memo on non-chosen assets by the retailer 105 according to an embodiment. The company asset division 111 can give 406 the assets on memo for selling, and the retailer 105 can offer 407 the assets for sale to the consumers 103. After the asset is sold, the retailer 105 receives 408 cash from the consumer 103 and places 409 the received cash into the banking division 110. In a further embodiment, the retailer gives 410 the assets, along with the memo, to the asset division 111 so as to have no dead inventory.

It is contemplated that, in an embodiment of the present invention, options to sell the goods on memo and pass on the profits from the memo in both directions may be offered. In this way, if dead inventory for one party is lying with another, it might sell for the other party if their client base is different. Furthermore, an investor may realize a benefit by buying an entire production lot from a manufacturer at a better price, even if he does not need all of the different goods in the lot, and then exchange what he does need with what he cannot sell. In this way, the retailer can create a better cash flow since his money is not tied up in dead inventory.

FIG. 4.3 illustrates a flow chart 400C for sale of retailer's chosen assets, according to an embodiment. It is contemplated that, in an embodiment of the present invention, the various parties to the investment will be able to quote their own prices while selling. The retailer 105 can decide on and place 411 a selling price on his chosen asset lying with the asset division 111. Additionally, the investment company 101 can place 412 the chosen asset for sale to an asset buyer 413. The sale amount received from the asset buyer 413 is transferred 414 to the banking division. Accordingly, the retailer 105 can choose 415 the sale amount to either re-invest 415a or cash out. If the retailer chooses 415 to re-invest and buy 416 new assets 417, the asset division can receive 418 the new assets from the asset supplier 115. In this way, a database or catalog of pricing data can be maintained in real time with the asset transactions in order to find actual, or near actual, pricing for an asset at any given time.

FIG. 4.4 illustrates a flow chart 400D for end of investment for the retailer 105 with the investment company 101 according to an embodiment. Accordingly, at the end of investment, the retailer 105 needs to make payments for amount due on memo and/or any taxes, if applicable. Further, all the investments are liquidated and returns on investment are sent 419 to the banking division 110, thereafter profit or loss on investment is paid 420 to the retailer 105. In a further embodiment, if the asset is not sold, the asset division 111 can send 421 the assets to the retailer 105.

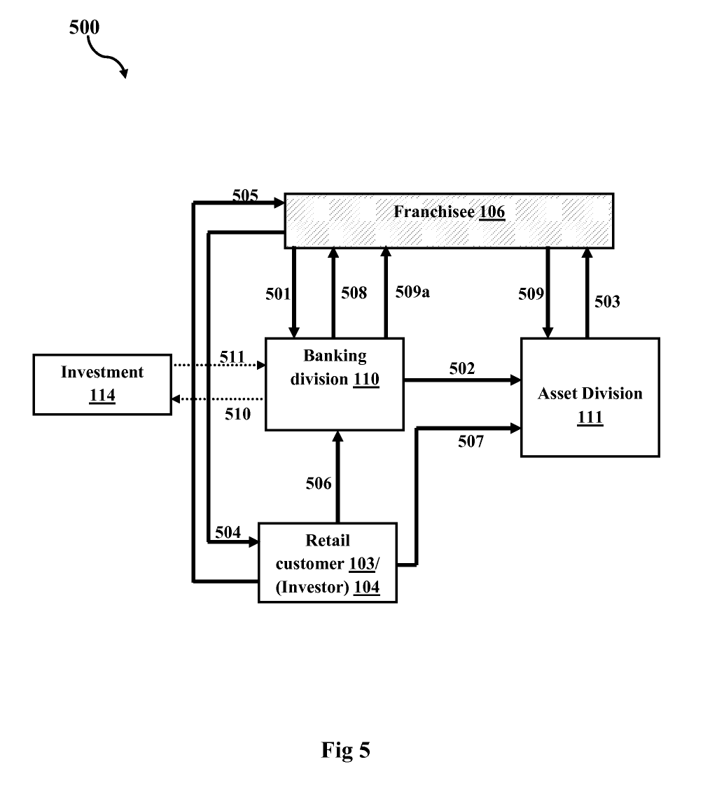

FIG. 5 illustrates a flow chart 500 of a franchisee's interaction with the investment company 101 according to an embodiment. The franchisee provides a retail presence, an online or physical store front, for the investment company. Accordingly, the franchisee 106 can invest 501 funds to the banking division 110 for choosing at least an asset. Further, the banking division 110 advises 502 the asset division 111 to send 503 the chosen asset to the franchisee 106. In this embodiment, the asset division may be sending goods from other investors and asset suppliers to the franchisee. It is contemplated that the asset owners may be different from the asset division. Additionally, the banking division 110 can give loans 509A against franchisee assets 509, therefore it can help to create free cash flow and reduce dead inventory.

In an embodiment, the franchisee 106 displays and/or shows 504 the asset to consumers 103 or other third parties, for selling or investing in the asset, The consumer 103 gives 505 cash or funds to the franchisee after completion of the transaction, or, alternatively, may pre-pay 506 the transaction in advance to the banking division 110 and then proceed to the franchisee. From now onwards, the consumer 103 also interacts 507 with the investment company 101 as explained in FIG. 2.1 to FIG. 2.5, according to their investment type. This interaction with the investment company may be accomplished via a website, mobile device, or other networked communication means. The banking division 110 pays 508 commissions or fees to the franchisee 106 as a commission on the transaction.

In an embodiment, in case the franchisee 106 is unable to sell the assets, then the franchisee 106 can return 509 the asset to asset division 111 and the bank division 110 pays out 509a to the franchisee 106 for the value of the unsold asset. In a further embodiment, at the end of investment, all the investments are liquidated 511, or assets are returned to the asset owners, or paid back 509a as per any buy back value, to the franchisee 106 after clearing the balances and accounts on memo by the franchisee 106.

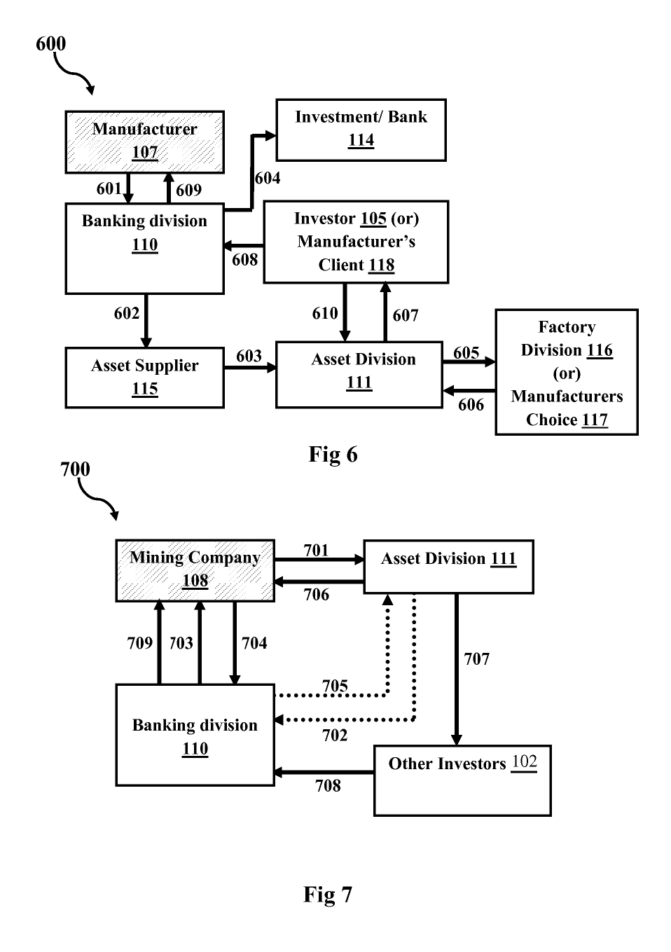

FIG. 6 illustrates a flow chart 600 of a manufacturer's interaction with the investment company 101, according to an embodiment. The manufacturer 107 can put 601 a certain amount of cash down to banking division 110 to fund a contract, wherein the cash down is determined based on credit risk. The contract can be between the banking division and the manufacturer. The banking division may also act as an intermediary between the manufacturer and a credit provider. The contracts may additionally be between the manufacturer and his buyer (investor 105 or client 118) for the manufacture of a particular product. The funded contract may also be for a manufacturer who is trying to make a product for future sale. The credit risk and cash down are a function of the cost of manufacturing, % of cost of hard asset, any finance charges based on parameters such as, but not limited to, contract type, time, and value. Further, the banking division 110 gives 602 percentages of cash based on a function of a combination of factors such as interest rates, and/or holding costs of the asset to the asset supplier 115 to receive 603 at least an asset at the asset division 111. Additionally, the banking division 110 can invest 604 the excess fund into the investment 114.

In an embodiment, the asset division 111 sends 605 the asset, along with additional funds as required as payment for services at this time or a later date, to the factory division 116b of the company 101 or to any third party 117 selected by the manufacturer 107 for making a finished product. Further, the finished product may be returned 606 to asset division 111 for sending 607 it to the retailer 105 or manufacturer's client 118 to sell the finished product. After the finished product is sold, the cash received 608 from the retailer 105 or manufacturer's client 118 is sent to the banking division 110. In addition, any profit or loss on the transaction is transferred 609 to the manufacturer 107.

In an embodiment, in case the finished product is not sold, then the investor 105 or manufacturer's client 118 can return 610 the finished asset to the asset division 111. Accordingly, the asset division 111 can advise on any or all of the liquidation value, buy back value, or melt value of the asset, which is pre-determined either at the time of contract or before return of finished product, and accordingly advises to the bank division 110. An option to buy the asset may also be provided. Further, the bank division 110 transfers 609 the cash to the manufacturer based on the value determined, and the manufacturer's account is settled, and finally the assets become part of the inventory in the asset division 111. In the event that the asset owner is a third party, and they have agreed to the liquidation, buy back, or melt value, then the asset is melted or broken down and returned to the asset owner.

FIG. 7 illustrates a flow chart 700 of a mining company's interaction with the investment company 101 according to an embodiment. Accordingly, the mining company 108 can send 701 an asset to the asset division 111. After verification 702 of the asset, the bank division 110, which can borrow from investors 102 based upon the physical assets as collateral, can give 703 cash with interest bearing to the mining company 108, or other forms of instruments as based on individual needs. Additionally, the mining company 108 returns 704 the cash, along with interest, if any, to the banking division 110 and the asset is returned 706 to the mining company 108, after verification 705 at banking division 110.

In an embodiment, the mining company 108 can send 701 at least an asset on memo to the asset division 111, wherein the asset division 111 can sell 707 the assets of the mining company to any of the investors 103-107,109 who is willing to buy and pay the cash. The buying investor can send 708 the cash to the banking division 110, and the received cash, after deducting finance charge, is given 709 to the mining company 108. According to an embodiment, an asset dealer (not shown) can also interact and invest with the investment company 101, as similar to the mining company 108.

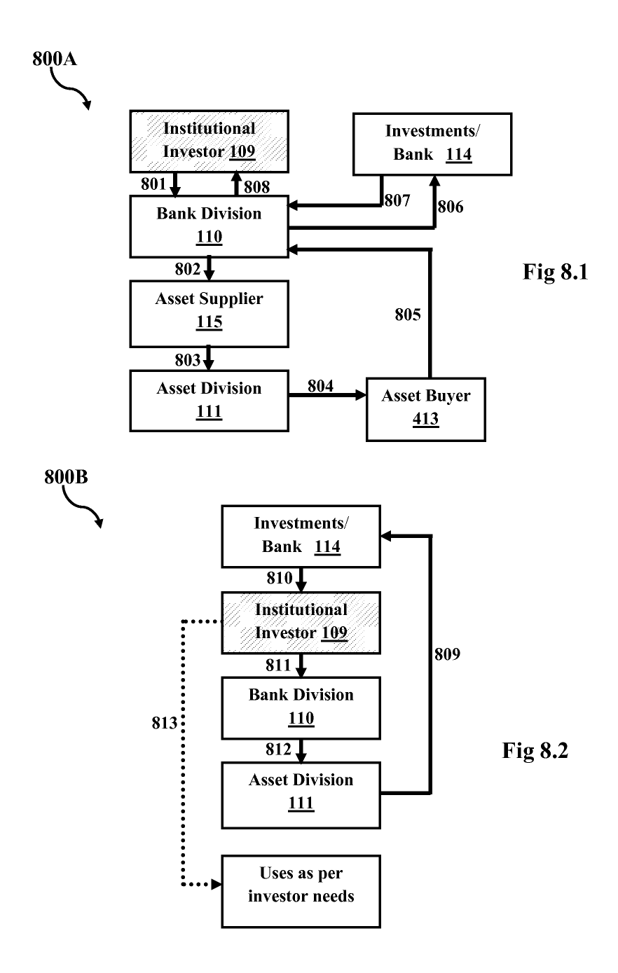

FIG. 8.1 illustrates a flow chart 800A of an institutional investor's interaction with the investment company 101 according to an embodiment. Accordingly, the institutional investor 109 can invest 801 funds into the banking division 110, wherein the received cash is utilized 802 to buy 803 at least an asset from asset supplier 115 to hold asset at asset division 111.

In an embodiment, the asset division 111 can offer to sell 804 the assets to at least an asset buyer 413, and the buyer 413 makes 805 the payment to the banking division 110 for the purchased asset, wherein the banking division 110 either re-invests into new hard assets 803 or puts 806 into other investment 114. At the end of investment, any profit or loss 807 from the investment is paid 808 to institutional investor 109.

FIG. 8.2 illustrates a flow chart 800B for borrowing or leveraging assets of an institutional investor holding with the investment company 101, according to an embodiment. Accordingly, the assets of institutional investor 109 held by the asset division 111 can be confirmed 809 to any third party or bank 114 for granting a loan on the investment. In response to the confirmation, the bank 114, or third party, can provide 810 a loan against asset owned by institutional investor 109. Now, the institution can use 813 the loan amount as per his need. In a further embodiment, the company 101 can also give a loan to the institutional investor 109 based on an asset held by the investor 109. The loan can be utilized for investing into new assets, wherein the new asset is placed in custody with the asset division 111. Any finance charges or loss on the held asset is to be borne by the institutional investor 109. It is contemplated as part of an embodiment of the present invention that the institutional investor may loan out the asset and still borrow against that loaned out asset from other parties who may be willing to accept the loaned out asset as collateral. As an example of the present embodiment, a government holding gold can, through an investment company, loan this gold to investors for a time period and receive income in various forms including, but not limited to: the loan amount itself; a credit instrument that may be given against this loan; a derivative created against the gold; and, in the case that the gold goes to the consumer, then the excess cash received as well as a part of the investment return is a form of income. The loaned gold is eventually returned to the government by the investors and the government pays the money back. In another example, the government can loan the gold, receive cash for the gold in domestic currency, and pay interest to the investors, while borrowing in foreign currency against the gold.

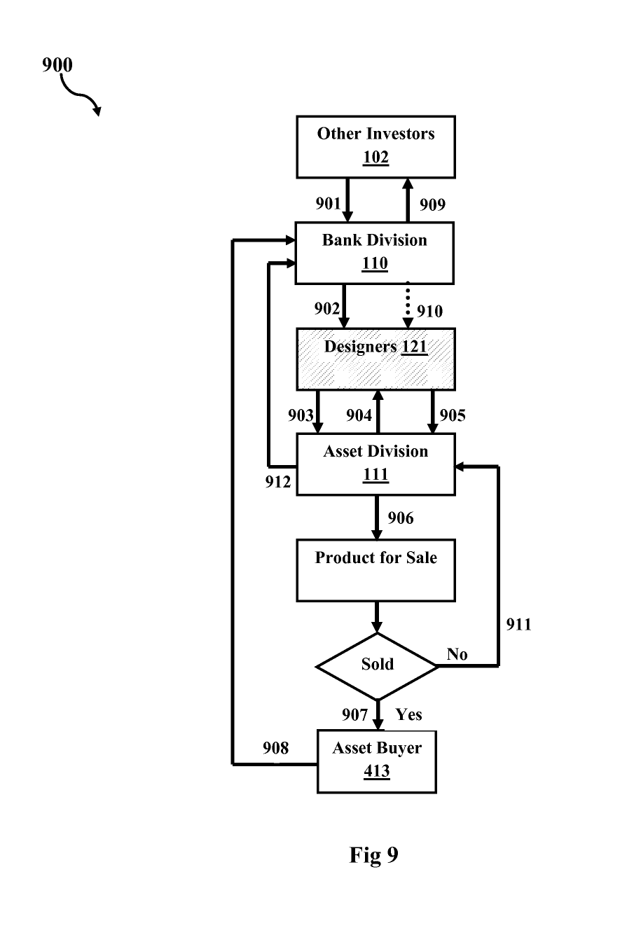

FIG. 9 illustrates a flow chart 900 of a designer's 121 interaction with the investment company 101, according to an embodiment. Accordingly, the other investors 102 can invest 901 cash fund into the bank division 110, for the purpose of financially backing the designer, as explained in above embodiments. In an embodiment, the designer 121 may receive 902 cash from the bank division 110 for purchasing the unfinished assets from asset division 111 as well as for making the design of an asset. In an embodiment, the designer 121 may make 903 cash payment to the asset division 111 to receive 904 unfinished assets. Thereafter, the designer 121 can prepare the design of the unfinished assets and send the finished assets to the asset division 111. The received finished asset would be made available for sale 906 by the asset division 111. In case the finished asset is sold 907 to the asset buyer 413, then the bank division 110 may receive 908 equivalent cash from the asset buyer 413, and the bank division may provide 909 return on investment and profit or loss to other investors 102, and also may provide 910 profit or loss to the designer 121. In case the finished asset is unsold, then the asset is returned 911 to the asset division 111 and the cash for the buyback, melt, cash out, or liquidation value of asset is returned 912 to the bank division 110. The recovered cash or asset may be returned to the other investors 102 according to an embodiment.

This embodiment allows designers to get funding from investors. Spreading the risk through the supply chain and away from a designer or a manufacturer who may be creative at his job but doesn't have the financial strength. The buy back clause will reduce dead inventory and give a lower loss limit to all the investors if the product does not sell. This will increase the investment appeal since the company is the guarantor or finds one for the investment.

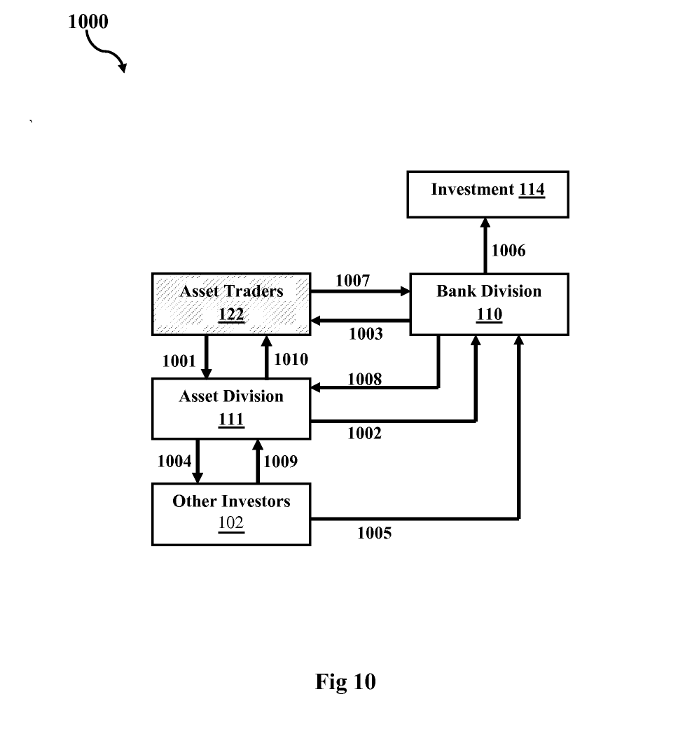

FIG. 10 illustrates a flow chart 1000 of a trader's 122 interaction with the investment company 101 according to an embodiment. Accordingly, the trader 122 may provide 1001 asset on memo to the asset division 111. After receipt of asset, the asset division 111 may advise 1002 receipt of asset to the bank division 110, and the banking division 110 may provide 1003 cash, after deducting the finance charge, to the traders 122 if needed. In an embodiment, the assets may be made available 1004 to other investors 102 to buy, hold, or sell the assets. The cash fund is received 1005 from the other investors 102 to the bank division 110, wherein excess cash can be invested 1006 into the investment 114. Further, the cash, after deducting finance charges, is provided 1003 to the traders 122. In an embodiment, the trader 122 can return the cash, along with interest, if any, to the bank division 110 for memo return. In an embodiment, the bank division 110 may advise 1008 receipt of fund to the asset division 111, and accordingly the asset would be received 1009 from other investors 102 for returning 1010 the asset to the trader 122.

In another embodiment, the embodiments described above, as well as other embodiments contemplated to be within the scope of the claims, can further enable an asset owner to monetize an asset as follows. The asset owner can transfer possession, but not ownership, of an asset to the investment company, or a representative of the investment company. This transfer can be made at a physical location, a retail setting, or, virtually, through an online portal or website. In exchange, the investment company provides to the asset owner a credit instrument based upon the asset. The investment company then offers the asset to the public under an investment instrument of one of the embodiments described above. When such an investment is entered into by a third party (e.g., a customer), then the third party takes possession, but not ownership, of the asset, and, optionally, also receives a credit instrument, under certain agreed-upon terms as described above.

For the duration of the investment, the third party provides a stream of payments that can be divided in any way between the various parties to the transaction. In some implementations, the above transaction can be implemented via a third-party facilitator, who may take a commission, fees, or other income for implementing the transaction.

In a further variation, there need not be a single owner for an asset. For example, several unrelated people can buy shares of an asset and receive an income stream as defined above. For example, if an asset worth $10,000 is made available for such an investment by a custodian, various independent parties can buy in to the asset, regardless of whether the independent parties have any ownership interest in the asset. The transaction would proceed as described above, except the various independent parties would receive a pro rata share of the resultant income stream, based on the proportion of the asset's value with which they have bought in. For example, an investor buying in to such an asset for $1,000 would receive a 1/10 share of the income stream associated with the asset as described above.

In yet another variation, an investment may be made by one or more investors in the one or more component parts of the investment asset. For example, in the case of an asset in the form of a piece of jewelry comprised of a precious stone set in a gold ring, a first investor may invest in the precious stone while a second investor may invest in the gold ring.

It is contemplated that practicing of the investment instrument as in any of the embodiments described herein will create futures options and contracts that will be enforceable at different times. For example, when an investor invests in an asset, such as jewelry, for a time period, such as five years, the investment contract for that time period is a futures contract. It is contemplated as part of the claimed investment instrument, that this futures contract can be bought and sold on a futures exchange or marketplace to another investor, or bought and sold between investors. In this way, the investment company can create a hedge on the investment or create a cash flow from the investment contract itself.

In the various embodiments of the investment instrument, as well as in other embodiments contemplated but not shown, the investor may have various options available at the end of the investment period. As mentioned above, the investor may have the option to buy the asset. Other options may be for the investment company to guarantee a percentage of an additional asset. In this case, the investment company may either take back the original asset and replace it with a new asset, or allow the investor to maintain possession of the original asset and give the new asset as well. A further option may be for the investment company to provide for an additional asset at a percentage value of the original investment. Any profit or loss in this case is only realized at the time that the investor sells the asset himself, which may or may not be through the investment company. Yet another option available to the investor may be to buy stock in or shares of the company either at the end of the investment term or at another point in time per the investment contract. The stock or share purchase may also be in the entity that owns the asset. In this case, the asset owner may have given to their employee(s) the asset(s) to wear or use as a perk for working there and can, through this investment instrument, convert the asset(s) into such an instrument that could be tradable on the markets.

Certain embodiments of the investment instrument described herein may include the option for the investor to receive a credit instrument that will enable him to purchase goods and services. It is further contemplated that a specialized marketplace may be created, either physical or online, in which an investor may either purchase goods and services using the credit instrument, or by exchanging assets in lieu of goods and services.

In the above embodiments, as well as in other embodiments contemplated but not shown, the investment company may determine an investor's credit limit by causing for the investor's financial data to be entered into a specially programmed computer which accesses the data, performs calculation on the data, and reports back to the investment company the investor's credit limit.

In some embodiments, the investment instrument may further comprise a method of turning an investment into money where an investor is provided with a credit instrument, from the investment company and/or a third party, for either, or both, an investment and an asset, or plurality of assets, purchased with the funds of the investment. An auction, or an option, is then created for the sale of the asset(s) and, upon the sale of the asset in the auction, or at option, the proceeds are given to the investor and ownership of the asset(s) is transferred to the winner of the auction, or exerciser of the option. The value of the credit instrument has then been determined based upon the value of the asset as derived at auction. The credit instruments provided can be further used to buy goods and services from the auction winners, at a profit to the investment company. The credit instruments provided can also be used to buy goods and services through the company's retail division or its designated providers.

In the embodiments disclosed herein, as well as in other embodiments contemplated to be within the scope of the claims, an asset may be exchanged for another asset throughout the term of the investment period. For example. During a five year investment period, an investor may choose a ring with a diamond setting as the investment asset and take possession of the ring. After two years, the investor may exchange the ring for another asset, such as a pair of earrings or a watch, for the remaining three years.

In some embodiments, the investment instrument may further comprise a method of turning an investment into money, hereinafter referred to as the “Parikh Process”, where an investor can choose to convert their investments into a credit instrument that can be used to buy goods and services from listed providers or through the company's retail division. Investors may also convert their investment into money on the futures exchange or marketplace. The Parikh Process is a method of converting a retail or wholesale purchase value of a product into a retail or wholesale value of another product using a credit instrument, a bid, exchange or offer process to convert an asset into a credit and then using said credit to purchase goods and services. The exiting of an investment is not always easy and often certain assets are not easy to exit. This method creates a further ease of exiting an investment. The steps of the Parikh Process comprise:
1) The investor putting the whole or part of the investment or the asset up for conversion using the “Parikh Process”; 2) the Investment company calculating and/or assigning a monetary value to the asset, wherein the monetary value is based on any contracts made, buy back value, cash out value, melt value or market forces; 3) the investor either accepting to convert to credit instrument based on this value, or: 4) choosing to have others bid on the value and then converting to credit instrument based on the valued and accepted bid by one or multiple bidders, or; 5) giving a value they want for their investment and letting a goods and service provider accept or reject it; 6) passing title to the bid winner or acceptor; 7) passing possession onto assigned entity (investment company, asset division, bid winner, etc.); 8) issuing credit instrument to buy the goods and services as and when needed; 9) providing for any goods and services and paying for said goods and services before possession is passed onto the bid winner; and 10) if investor accepts investor company's bid (#2) then they are free to choose from multiple vendors at retail division else they can choose to go to the service and goods provider they want to buy from and let them bid for their assets.
   Furthermore, in the embodiment known as the Parikh Process, described above, assets may imply just the asset or any markups or investments and return on investments made over the period of investment. Credit instruments can be given at any time during the transaction or can be the one already given or in use. Such credit instruments are then funded as values are known or funded with approximate values assigned by the investment company to facilitate smoother or faster ease of use if asset is difficult to value or, sell, get an offer on etc. In this case, the possession of the asset may need to be in the hands of the investment company. Bid winners may be one or more than one entity or investor. The asset may be one or a plurality of assets. Any profit or loss on the investment is based on credit received or product and services buyable. Taxes and fees are calculated and balances paid out. Bid winners may further have the need, or be presented with an option, to get a guaranteed sell back value from the investment company or the next highest bidder(s) and pass on the possession and ownership to that entity who funds this transaction through various sources.

It is contemplated to be within the scope of the invention that various embodiments thereof may result in the creation of various financial instruments. For example, where an asset seller may sell an asset without having it on hand, he can ask for time to provide it to the investor. This would create a futures contract. He would have to provide or borrow or buy from others to fill this contract.

The above embodiments shall preferably be implemented via a specially programmed computer system. For example, a client/server architecture can be employed whereby each participant (investor, retailer, bank, etc.) can interact as a client with a central facilitation platform acting as a server to implement the above transactions. The facilitator can also function as an online retail location, acting to disseminate information from willing participants to other willing participants. Such information can include, for example, an inventory of assets available for investments as described above, particular terms of the investment, desired assets or desired terms (from investors). The computer based system can also provide a cataloguing of assets invested in, and/or available to, an investor where the catalogue would list assets, their value, qualities, a breakdown of the asset value per its individual qualities, and other parameters, and provide to the investor a cross-reference of goods and services available in exchange for each asset based upon its value, qualities, etc. . . . .

It is contemplated to be within the scope of the claims of the present invention, that an embodiment of the investment instrument described herein may be a computer program product for transforming and enabling a computer to practice an embodiment of the invention, the computer program product comprising: software instructions that transform the computer and enable it to perform predetermined operations, said predetermined operations being carried out by an ordering server programmed to carry out the steps of the predetermined operations; and a non-transitory computer readable storage medium on which the software instructions are stored. The predetermined operations include, but are not limited to: storing on a non transitory computer readable storage medium a database containing information relevant to the transaction, wherein said information comprises data about the parties to the transaction, data about the asset, cost of acquisition, markup, investments, and offers; presenting the option to initiate a transaction session via a user interface; initiating a transaction session upon receipt of input via the user interface; assigning the offeror as a first party in the transaction session; receiving information input about the offeree via the user interface; assigning the offeree as a second user in the transaction session; storing information about the first user in a database on a non-transitory computer readable storage medium; accessing the database by a processor; analyzing the information in the database; generating one or more offers for the transaction session; displaying to the second user, via a user interface, the first user's offers; receiving input from the second user, via a user interface, of acceptance or rejection of one or more of the first user's offers; terminating the transaction session if said second user's input relating to all of the first user's offers are rejections; presenting to the second user, via a user interface, further instructions to continue with the transaction session if at least one of the first user's offers are accepted, said instructions to include payment terms; initiating a funds transfer from the second user to the first user per said payment terms; issuing a credit instrument from the first user to the second user based upon the terms of the offer, the credit instrument being valid for a first time period; issuing a notice to the first user to transfer possession of the asset to the second user for a second time period, without transferring legal ownership of the asset to the second user; and issuing a notice at the expiration of the second time period offering an option to purchase the asset vesting in the investor, whereby the computer program product implements a transaction between two or more parties. This computer program product may further perform the above described transaction wherein the transaction is with respect to a plurality of assets.

In another embodiment, the predetermined operations of the computer program product may further comprise: calculating profit or loss on investment; calculating interest due to owners; calculating additional fees; calculating the value of the investment at a given period of time using values from a processor accessible data set, wherein said processor accessible data set is at least of the type including stored data about the asset, the value of the investment as put into other assets, the equivalent cash value at current market prices, real-time values, and stored values; generating different contracts between the various parties to the transaction; and processing of said contracts, whereby the computer program product implements and completes a transaction between two or more parties.

In the event that the second user chooses to not take physical delivery of the asset, the predetermined operations of the computer program product may further comprise: allowing the second user to take a credit instrument based on the value of the asset; issuing said credit instrument to said second user; and allowing said second user to list or hold the investment for sale or lease to a third party.

In a further embodiment, the computer program product may issue a notice wherein the notice issued at the expiration of the second time period offers an agreement, with respect to the asset, between the actual owners, the second party, and the investment company.

An embodiment of the investment instrument described herein comprises a computer-implemented method of turning an investment into money, said method being carried out by an ordering server programmed to carry out the steps of the method, which comprise: providing to an investor a credit instrument for an investment and an asset or plurality of assets purchased with the investment; generating an auction for the sale of said asset; transferring the proceeds of said auction to said investor; and transferring ownership of said asset to the winner of said auction.

Another embodiment of the investment instrument described herein comprises a computer-implemented method of turning an investment into money, said method being carried out by an ordering server programmed to carry out the steps of the method, which comprise: providing to an investor a credit instrument for an investment and an asset or plurality of assets purchased with the investment; accessing a database of registered retailers that have agreed to accept said asset or assets as payment, with or without the cash value of the investment, for their products or services; brokering a retail sales transaction between a said registered retailer and said investor utilizing said asset or assets as payment for said products or services; and transferring ownership of asset or assets to said registered retailer. This embodiment of the computer-implemented method of practicing the investment instrument described herein may further comprise creating a part ownership in the asset or assets if the amount spent is less than the value of the product or service offered.

The above systems, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionality may be integrated into a dedicated, standalone device. All such permutations and combinations are intended to fall within the scope of the present disclosure.

In some embodiments disclosed herein are computer program products comprising computer-executable code or computer-usable code that, when executing on one or more computing devices (such as the devices/systems described above), performs any and/or all of the steps described above. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the processes described above may be embodied in any suitable transmission or propagation medium carrying the computer-executable code described above and/or any inputs or outputs from same.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The meanings of method steps of the embodiments described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

Thus for example, a description or recitation of “adding a first number to a second number” includes causing one or more parties or entities to add the two numbers together. For example, if person X engages in an arm's length transaction with person Y to add the two numbers, and person Y indeed adds the two numbers, then both persons X and Y perform the step as recited: person Y by virtue of the fact that he actually added the numbers, and person X by virtue of the fact that he caused person Y to add the numbers. Furthermore, if person X is located within the United States and person Y is located outside the United States, then the method is performed in the United States by virtue of person X's participation in causing the step to be performed.

While particular embodiments of the present invention have been shown and described, it will be apparent to those skilled in the art that various changes and modifications in form and details may be made therein without departing from the spirit and scope of the invention as defined by the following claims. The claims that follow are intended to include all such variations and modifications that might fall within their scope, and should be interpreted in the broadest sense allowable by law.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

What is claimed is:

1. A computer program product for transforming and enabling a computer to implement a method for an investor to invest in at least an asset through an investment company, the method comprising the steps of: establishing at least an investor and an investment company; providing to said investor a selection of assets for investment; selecting at least an asset for investment by said investor; communicating a payment amount and payment terms to the investor for investment in the chosen asset; if accepted, tendering said payment amount from the investor to the investment company; delivering possession, but not ownership, of said asset to the investor for a first time period; issuing a credit instrument on the investment by the investment company to the investor for a second time period; and investing of the payment amount by the investment company; the computer program product comprising:
software instructions that transform the computer and enable it to perform predetermined operations, said predetermined operations being carried out by an ordering server programmed to carry out the steps of the predetermined operations; and
a non-transitory computer readable storage medium on which the software instructions are stored;
the predetermined operations including:
storing on a non transitory computer readable storage medium a database containing information relevant to the transaction, wherein said information comprises data about the parties to the transaction, data about the asset, cost of acquisition, markup, investments, and offers;
presenting the option to initiate a transaction session via a user interface;
initiating a transaction session upon receipt of input via the user interface;
assigning the offeror as a first party in the transaction session;
receiving information input about the offeree via the user interface;
assigning the offeree as a second user in the transaction session;
storing information about the first user in a database on a non-transitory computer readable storage medium;
accessing the database by a processor;
analyzing the information in the database;
generating one or more offers for the transaction session;
displaying to the second user, via a user interface, the first user's offers;
receiving input from the second user, via a user interface, of acceptance or rejection of one or more of the first user's offers;
terminating the transaction session if said second user's input relating to all of the first user's offers are rejections;
presenting to the second user, via a user interface, further instructions to continue with the transaction session if at least one of the first user's offers are accepted, said instructions to include payment terms;
initiating a funds transfer from the second user to the first user per said payment terms;
issuing a credit instrument from the first user to the second user based upon the terms of the offer, the credit instrument being valid for a first time period;
issuing a notice to the first user to transfer possession of the asset to the second user for a second time period, without transferring legal ownership of the asset to the second user; and
issuing a notice at the expiration of the second time period offering an option to purchase the asset vesting in the investor, whereby the computer program product implements a transaction between two or more parties.

2. The computer program product of claim 1 wherein the transaction is with respect to a plurality of assets.

3. The computer program product of claim 1 wherein the predetermined operations further comprise:
calculating profit or loss on investment;
calculating interest due to owners;
calculating additional fees;
calculating the value of the investment at a given period of time using values from a processor accessible data set, wherein said processor accessible data set is at least of the type including stored data about the asset, the value of the investment as put into other assets, the equivalent cash value at current market prices, real-time values, and stored values;
generating different contracts between the various parties to the transaction; and
processing of said contracts, whereby the computer program product implements and completes a transaction between two or more parties.

4. The computer program product of claim 1 wherein, if the second user chooses to not take physical delivery of the asset, the predetermined operations further comprising;
allowing the second user to take a credit instrument based on the value of the asset;
issuing said credit instrument to said second user; and
allowing said second user to list or hold the investment for sale or lease to a third party.

5. The computer program product of claim 1 wherein, the notice issued at the expiration of the second time period offers an agreement, with respect to the asset, between the actual owners, the second party, and the investment company.

6. A computer-implemented method of turning an investment into money, said method being carried out by an ordering server programmed to carry out the steps of the method, which comprise:
providing to an investor a credit instrument for an investment and an asset or plurality of assets purchased with the investment;
generating an auction for the sale of said asset;
transferring the proceeds of said auction to said investor; and
transferring ownership of said asset to the winner of said auction.

7. A computer-implemented method of turning an investment into money, said method being carried out by an ordering server programmed to carry out the steps of the method, which comprise:
providing to an investor a credit instrument for an investment and an asset or plurality of assets purchased with the investment;
accessing a database of registered retailers that have agreed to accept said asset or assets as payment, with or without the cash value of the investment, for their products or services;
brokering a retail sales transaction between a said registered retailer and said investor utilizing said asset or assets as payment for said products or services; and
transferring ownership of asset or assets to said registered retailer.

8. The computer-implemented method of claim 7 wherein the steps of the method further comprise creating a part ownership in the asset or assets if the amount spent is less than the value of the product or service offered.
